(19) United States
(12) Patent Application Publication
(10) Pub. No.: US 2021/0042722 A1
(43) Pub. Date: Feb. 11, 2021

(54) DEFERRED TRANSACTION PROCESSING

(71) Applicant: Square, Inc., San Francisco, CA (US)

(72) Inventors: Jonathan Andrew Wolter, San Francisco, CA (US); Gian Perrone, San Francisco, CA (US); Paul Aaron, San Francisco, CA (US)

(21) Appl. No.: 17/079,831

(22) Filed: Oct. 26, 2020

Related U.S. Application Data
(63) Continuation of application No. 15/197,412, filed on Jun. 29, 2016, now abandoned.

(51) Int. Cl. G06Q 20/10; G06Q 20/20

(52) U.S. Cl. CPC G06Q 20/10; G06Q 20/202; G06Q 20/206

(57) ABSTRACT

An automated online payment system may be used to process purchase payments between a buyer and a seller. When a payment is requested, the payment system may determine whether the corresponding purchase satisfies a purchase criterion, and if so, may defer certain aspects of settling the payment. For example, the payment service may determine the risk of deferred settlement and the likelihood that the buyer will make a subsequent purchase from the seller within a relatively short time period. If there is a low risk and high likelihood of a future purchase, the payment service may authorize the payment, but may defer capture of the payment until the buyer makes the subsequent purchase.

### RELATED APPLICATIONS

This application claims priority to U.S. patent application Ser. No. 15/197,412, filed Jun. 29, 2016, which is incorporated herein by reference.

### BACKGROUND

A seller may utilize the services of an online transaction processing service for conducting purchase transactions with buyers and for processing payments by buyers using payment instruments such as credit cards or debit cards.

Some types of sellers rely on high volume sales of low-cost items. When selling low-cost items, however, the bank fees associated with credit card or debit card transactions can be significant. This is because there is a per-transaction fee component imposed by card processing services, which remains relatively constant regardless of the transaction amount. With smaller purchases, this fee becomes a significant percentage of the transaction amount.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram of an example payment system that implements techniques for deferring and aggregating settlements of certain purchase transactions.

FIG. 2 is a flow diagram illustrating an example method of deferring and aggregating settlements of certain purchase transactions.

FIG. 3 is a flow diagram illustrating an example method of evaluating a risk criterion.

FIG. 4 is a block diagram of an example device that may be an example of a seller point-of-sale device or of a buyer device.

FIG. 5 is a block diagram of an example server that may be used to implement the transaction payment service described herein.

### DETAILED DESCRIPTION

An online transaction payment service may be configured to process payments for purchases between buyers and sellers. The payment service, herein variously referred to as transaction service, transaction payment service, online payment transaction service, online transaction processing service, and the like, may support the use of bank cards, such as debit cards, credit cards, or other similar types of payment instruments, which may involve transfers of funds between bank accounts of the buyers and sellers. There are fees imposed by banking institutions, known as interchange assessments, for completing such funds transfers.

The payment service may, for example, be used by merchants to complete sale transactions with customers. A merchant may have a POS (point-of-sale) device through which the merchant specifies information regarding transactions, and the POS device may communicate with the payment service in order to process customer payments for the transactions. The POS device may, for example, allow the merchant or the merchant's customers to provide payment instrument information, such as by swiping credit cards or debit cards. The payment instrument information may then be provided to the transaction payment service. The transaction payment service may then interact with the appropriate financial institutions on behalf of the merchant in order to transfer funds between the merchant and the customer.

As another example, a person may use an application, such as a web browser or an e-commerce application, installed on a smartphone or other computerized device to purchase products from a seller. The application may be designed to obtain transaction information from the buyer, including payment instrument information such as credit card numbers. The application may then interact with the payment service to provide transaction details, including the payment instrument information, and the payment service may then complete funds transfers between the buyer and the seller.

Credit card and debit card transactions are typically settled using what are known as authorizations and captures. An authorization is a request to an issuing bank of a payment instrument to determine, prior to completion of a sale, that the buyer is authorized to use the payment instrument and that there are sufficient funds available to cover the cost of the transaction. A capture is a request to initiate the actual funds transfer, and is typically performed after obtaining authorization. In some cases, the capture may be for an amount larger or smaller than the amount of the authorization. For example, a tip may be added to a purchase amount and captured in addition to the originally authorized amount.

Some types of sellers may have buyers who make small purchases with predictable frequency. For example, a coffee shop or deli may have buyers that predictably purchase the same or similar items every morning. As another example, a bar may have buyers that purchase multiple drinks during a single evening. As yet another example, a taxi service may have riders that use the service every morning and evening. In cases such as these, the payment service may defer certain credit card or debit card processing steps in order to aggregate repeated purchases by a buyer over time and to thereby minimize per-transaction processing fees.

When processing a payment that is to be made by a buyer from a seller using a payment instrument such as a credit card or debit card, the payment service may first submit an authorization request to an issuing bank. Upon receiving approval of the authorization, the payment service may submit a capture request in order to initiate an actual transfer of funds from the account of the buyer to the account of the seller. In some cases, the capture request may be submitted along with the authorization request.

In accordance with embodiments described herein, the payment service evaluates a purchase to determine whether the purchase meets a deferment criterion. If the purchase meets the criterion, settlement of the purchase payment is deferred, and the amounts of subsequent purchases by the buyer are aggregated with the amount of the first purchase prior to capture.

As one example, the deferment criterion may specify a purchase amount threshold, and captures for purchase amounts less than the threshold will be deferred. As another example, the deferment criterion may relate to the purchasing history of the buyer, and a purchase may qualify for deferment when it is predicted that the buyer will make another purchase from the seller within a relatively short time. As yet another example, the deferment criterion may involve an evaluated risk of deferring settlement of the purchase, such as the risk of chargebacks. In practice, the deferment criterion may be based on a combination of these different factors.

Upon determining that a purchase meets the deferment criterion and that settlement of the purchase payment will be deferred, the payment service may nevertheless submit an authorization request to the issuing bank. Such an authorization request may be for the amount of the purchase or for a larger amount. Authorization for a larger amount may be requested to cover anticipated future purchases by the buyer, as an example. In some situations, the authorization may be omitted, pending further purchases by the buyer.

Additional payment requests for purchases of the buyer from the seller may occur after the initial purchase. Settlements for these purchases may also be deferred, assuming that they also meet the criterion. At the end of a specified time period or after the aggregate purchase amount reaches a threshold, the aggregate purchase amount may be captured as a single transaction, including a single corresponding service fee.

Authorizations for purchases whose settlements are being deferred may be made in various ways. For example, authorizations may be deferred until just before capture. As another example, an initial authorization may be submitted contemporaneously with the first transaction for an amount that is larger than the amount of the first transaction, to cover subsequent transactions. As yet another example, an authorization may initially be made for the amount of the first transaction, and a larger amount that includes subsequent purchases may be captured as an over-capture, which is a mechanism typically used to add a tip amount to a previously authorized transaction amount.

The risk criterion is designed to balance potential per-transaction savings against the risk of non-collection and potential customer confusion or dissatisfaction. Customer confusion or dissatisfaction may arise at times because the deferred charges may not appear on a customer's statement for some time after the corresponding purchases. In addition, certain types of authorizations that are used when deferring payments may at times seem inconsistent with actual purchases.

Savings that result from reduced per-transaction fees may benefit the payment service or may be passed to the merchant or customer. In some embodiments, merchants or customers may be asked to opt in to a program that uses deferred settlement. In the case of merchants, opting in to the program may also mean that the merchant bears the risk of non-collection.

The payment service may expose one or more APIs (application programming interfaces) that may be used by either a merchant POS device or a personal device of a buyer to access the payment service. As an example, a seller may provide an application that runs on mobile devices such as smartphones, and that accesses the payment service through the APIs. Similarly, a seller may provide an e-commerce website that accesses the payment service through the APIs. Using the APIs, the application or website can submit and process transactions without being involved in the details and complexity of the deferment and settlement decisions that are being made by the payment service.

Furthermore, while each seller may have data regarding its own sales, the payment service is able to analyze a much larger set of data in order to determine the potential benefits of settlement deferment. For example, the payment service may have historical records of purchases by a particular buyer that are not limited to purchase from any one seller. Similarly, the payment service may have historical records of sales by multiple merchants. Because the payment service can analyze this much larger set of data, the payment service is in a better position than the seller to determine exactly which transactions might benefit from settlement deferment.

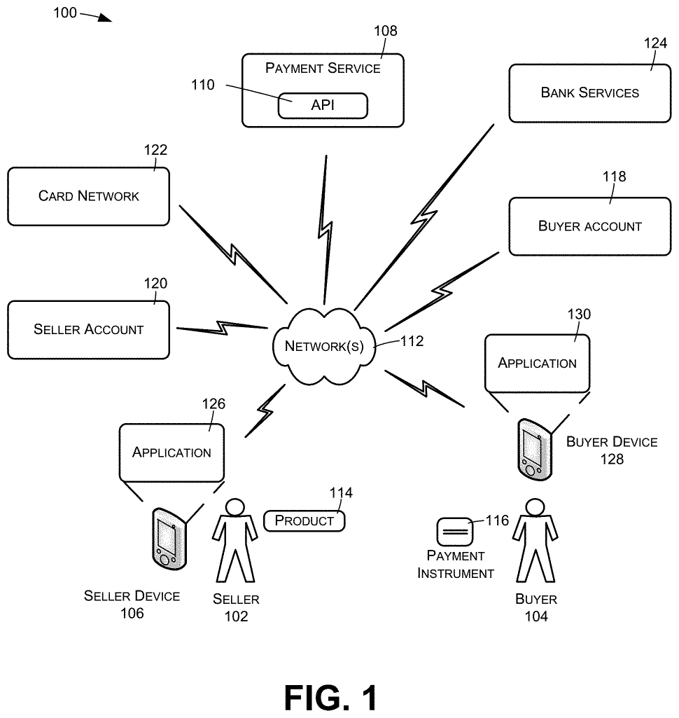

FIG. 1 illustrates an example system 100 that conducts and/or facilitates purchase transactions between buyers and sellers. For purposes of discussion, FIG. 1 shows a single seller 102 and a single buyer 104. The seller 102 has an associated seller device 106, which may comprise a point-of-sale (POS) device. The seller device 106 is supported by an online payment transaction service 108, which is also referred to herein as a payment service.

The payment service 108 may in some embodiments comprise an online service that processes payment transactions for multiple sellers. Specifically, the payment service 108 may comprise a service that interacts with banking institutions, including issuing banks and/or credit/debit card networks, to perform funds transfers based on payment instruments such as credit cards or debit cards.

The payment service 108 exposes a network-based API (application programming interface) 110, such as a web service, through which the payment service 108 provides services to various clients and client devices. The seller device 106 communicates through the API 110 with the payment service 108 over a wide-area network (WAN) 112, such as the public Internet, using secure communication protocols. In response to various communications with the seller device 106, the payment service 108 processes purchase transactions on behalf of the seller 102. In practice, the payment service 108 may process purchase transactions on behalf of multiple sellers 102. Processing the purchase transactions may comprise interacting with various services to transfer funds from buyers to sellers based on payment instruments such as credit cards and debit cards.

The seller 102 and the buyer 104 interact with each other to complete a purchase transaction in which the buyer 104 acquires a product 114 from the seller 102, and in return, the buyer 104 provides payment to the seller 102. The term “transaction” includes any interaction for the acquisition of a product in exchange for payment. The term “product” includes goods and/or services. The term “buyer” includes any entity that acquires products from a seller, such as by purchasing, renting, leasing, borrowing, licensing, or the like. The term “seller” includes any business or entity engaged in the offering of products for acquisition by buyers. Actions attributed to a seller may include actions performed by owners, employees, or other agents of the seller.

The buyer 104 may provide payment a payment instrument 116 such as a debit card or credit card. Payment may also be made through an electronic payment application on a buyer mobile device, such as a smartphone carried by the buyer 104.

When the buyer 104 and the seller 102 enter into an electronic purchase transaction, the seller 102 interacts with the seller device 106 to provide payment information and to identify products that are being purchased. The seller may input (e.g., manually, via a magnetic card reader or an RFID reader, etc.) a credit card number or other identifier of the payment instrument 116. For example, the payment instrument 116 may include one or more magnetic strips for providing card and buyer information when swiped in a card reader associated with the seller device 106. In other examples, other types of payment instruments may be used, such as smart cards having built-in memory chips that are read by the seller device 106 when the cards are “dipped” into the reader, smart cards having radio frequency identification devices (RFIDs), and so forth.

Purchase transaction information may include an identifier of the payment instrument (such as a credit card number and associated validation information); an identification of a card network associated with the payment instrument; an identification of an issuing bank of the payment instrument; an identification of a buyer with whom the purchase transaction is being conducted; a total amount of the purchase transaction; the products acquired by the buyer in the purchase transaction; the purchase prices of the individual products; the time, place, time, and date of the purchase transaction; the product category of each purchased product; and so forth. The seller device 106 sends such transaction information to the transaction service 108 over the network 112, either contemporaneously with the transaction (in the case of online transactions) or later when the seller device 106 is online.

In response to receiving the transaction information, the payment service 108 processes the corresponding purchase transaction by electronically transferring funds from a financial account 118 associated with the buyer 104 to a financial account 120 associated with the seller 102. The transaction service 108 may communicate with one or more computing devices of a card network 122 (or “card payment network”), e.g., MasterCard®, VISA®, over the network 112 to conduct financial transactions electronically. The transaction service 108 can also communicate with bank services 124 of one or more banks, processing/acquiring services, or the like over the network 112. For example, the transaction service 108 may communicate with computerized services of an acquiring bank, and/or an issuing bank, and/or a bank maintaining buyer accounts for electronic payments.

The seller device 106 may comprise any sort of mobile or non-mobile computer device, such as a tablet computer, smartphone, personal computer, laptop computer, etc. A seller application 126 executes on the seller device 106 to provide POS functionality to the seller device 106. The application 126 may communicate with the payment service 108 using the network-based APIs 110 that are exposed by the transaction service 108. The application 126 may be provided by the payment service 108 or may be provided by a third-party entity.

In some types of businesses, the seller device 106 may be located in a store or other place of business of the seller 102, and thus may be at a fixed location that does not change on a day-to-day basis. In other types of businesses, however, the location of the seller device 106 may change from time to time, such as in the case that a seller operates a food truck, is a street vendor, is a cab driver, etc., or has an otherwise mobile business, e.g., in the case of sellers who sell products at buyer's homes, places of business, and so forth.

In some situations or embodiments, the buyer 104 may have a personal electronic device 128, such as a smartphone, which the buyer uses to purchase products from the seller 102. The buyer device 128 may have an application 130, which may be provided by the seller 102, by the transaction service 108, or by another entity. The buyer 104 may use the application 130 to purchase products from the seller 102 without visiting the premises of the seller 102. The application 130 may communicate with the payment service 108 using the network-based APIs 110 of the payment service 108.

The application 130 may allow the buyer 104 to browse products of the seller 102, to select products for purchase, to provide payment information, and to complete transactions. Products available through the application 130 may include downloadable products such as music, movies, audio, etc., and/or physical products, including services, that are shipped to or otherwise provided to or for the buyer 104.

In addition to supporting payment processing, the payment service 108 may in some cases may support and facilitate inventory services, catalog services, shopping cart services, and various other services that may be useful by the seller 102 in conducting an online business.

The buyer device 128 may comprise any sort of mobile or non-mobile computer device, such as a tablet computer, smartphone, personal computer, laptop computer, etc.

The transaction service 108 may be implemented by one or more server computers and associated software components that provide the functionality described herein.

A purchase transaction may be initiated using either the seller application 126 or the buyer application 130. When conducting a purchase, the seller application 126 or the buyer application 130 sends a transaction request to the payment service 108, specifying various transaction data such as payment instrument information and an amount of the requested purchase. In response, the payment service 108 interacts with the card networks 122 and bank services 124 in order to transfer a transaction amount from the buyer account 118 to the seller account 120. This process involves authorization requests and capture requests as described above.

The authorization and capture requests for purchase by the buyer 104 from the seller 102 are timed and submitted in accordance with techniques that will be described below. Generally, captures for one or more qualifying purchases are deferred in order to aggregate the amounts of multiple small transactions into a single aggregated capture request. This serves to reduce the overall card servicing fees. In particular, aggregating multiple small transactions in this manner results in only a single per-transaction interchange assessment rather than multiple per-transaction interchange assessments corresponding respectively to the multiple individual purchases.

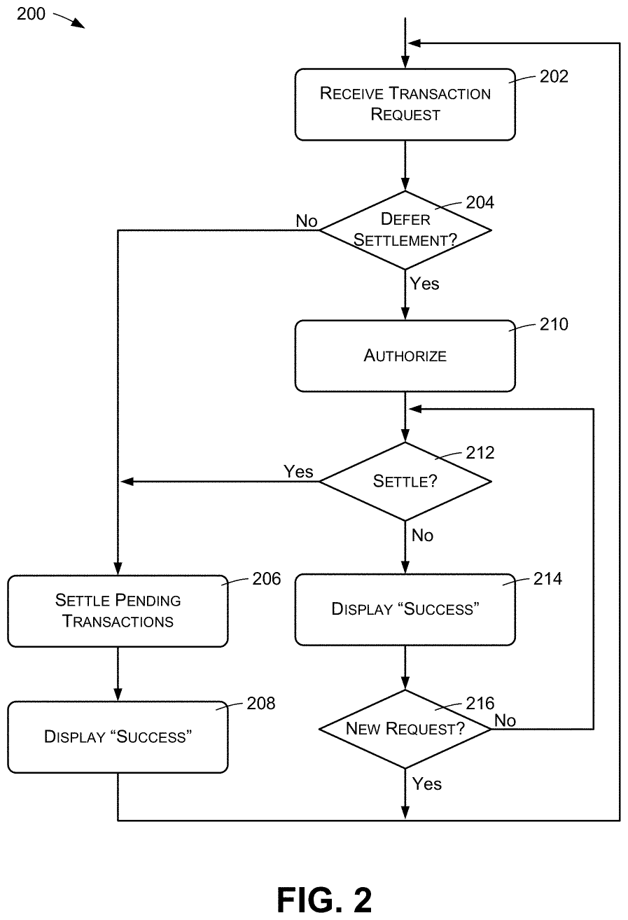

FIG. 2 illustrates an example method 200 for processing purchase transactions in order to aggregate small purchases and to thereby reduce per-transaction interchange assessments or other service fees. The method 200 may be performed by the payment service 108 in an environment such as shown by FIG. 1, in which transactions are submitted to the payment service 108 for payment processing. The method 200 may also be performed in other environments. For example, the method 200 may be performed in any environment in which an automated service processes charges, such as credit card charges or debit card charges, on behalf of sellers and/or buyers.

In the illustrated example, the method 200 is performed in response to receiving transaction requests, wherein the transaction requests correspond to purchases being conducted between sellers and buyers. Generally, the method 200 comprises receiving transaction requests for purchase amounts, potentially deferring settlement of certain qualifying purchases, and eventually settling any purchases whose settlements have been deferred. The method involves a criterion for deciding upon the purchases for which settlement will be deferred. The method also determines when deferred settlements should be completed. The method 200 may be performed repeatedly as new transaction requests are received.

Transaction requests may be received from different sources, including different types of devices. As one example, seller POS devices may communicate through the API 110 to provide transaction requests to the payment service. As another example, buyer devices may communicate through the API 110 to provide transaction requests to the payment service. In particular, applications that users have installed on their devices may communicate through the API 110 to provide transaction requests. As another example, a website may be designed to communicate with the payment service through the API 110.

An action 202 comprises receiving a transaction request. In the environment of FIG. 1, a transaction request may be received from the seller application 126 or the buyer application 130. The transaction request is for a purchase by the buyer from the seller for a purchase amount.

Over time, numerous transaction requests are received for purchases from the seller 102. Each transaction request specifies various transaction data, which may include an itemization of products, the prices of the products, the time and date of the transaction, a total transaction amount, payment instrument information, and/or other types of information depending on the capabilities of the transaction service 108 and the types of support provided by the transaction service 108. Most relevant to this discussion, the transaction information specifies a requested purchase amount or information allowing the transaction service 108 to determine a requested purchase amount.

A history of transaction requests and additional data relating to the processing and resolution of the transaction requests may be stored by the payment service as historical transaction data and used as training data when creating predictive models for various purposes as will be described below.

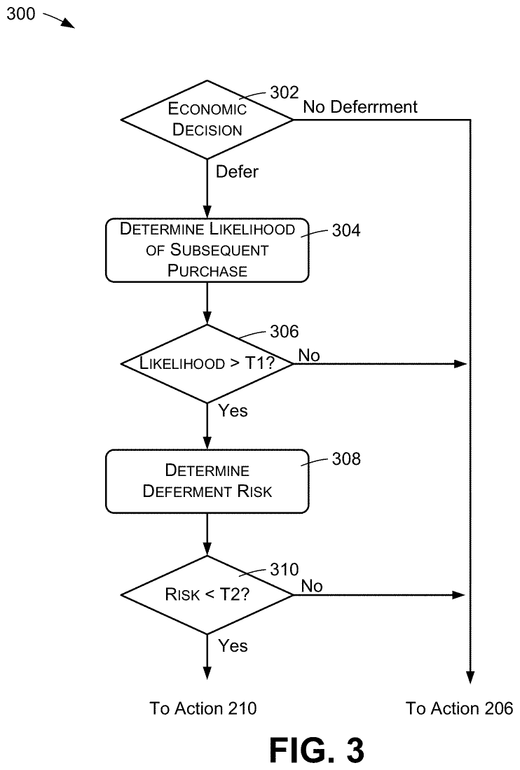

An action 204 comprises determining whether to defer settlement of the requested purchase. The action 204 may comprise determining whether the requested purchase satisfies a deferment criterion. For example, a deferment criterion may specify a threshold transaction amount, and transactions for amounts less than the threshold transaction amount may qualify for capture deferment. An example method for implementing a deferment criterion will be discussed below with reference to FIG. 3.

If the purchase does not qualify for deferment, an action 206 is performed of settling the purchase along with any previously deferred purchases. In some cases, settlement may include one or more authorizations followed by a single capture of an aggregate amount of the purchase transaction or of the aggregated purchase transactions. In other cases, a single capture of an aggregate transaction amount may be performed based on an earlier authorization request.

An action 208 is then performed of indicating, to the requesting entity or device, that the received transaction has been successfully processed. For example, the payment service may send a communication to the seller device or to the buyer device, causing the device to display, via a display, an indication that the purchase amount of the transaction has been settled.

If the purchase qualifies for deferment by satisfying the deferment criteria, an action 210 is performed of submitting an authorization request for the purchase amount. The authorization may be for the amount of the purchase or may be for a higher amount to allow for aggregated capture of subsequent purchase amounts. In some embodiments or situations, the action 210 may be omitted, and authorization may be performed instead when eventually capturing the purchase amounts, such as in the action 206. Furthermore, the action 210 may be omitted in some situations in which an authorization has already been performed for a purchase between the seller and the buyer, and/or where a previous authorization was for an amount greater than the purchase amount of the previous purchase.

Generally, in certain embodiments, the action 210 may comprise performing a transaction processing action comprising at least one of:
(a) deferring authorization of the purchase amount of the transaction by;
(b) authorizing an overcharge amount that is greater than the purchase amount and deferring capture of the purchase amount; or
(c) capturing an over-authorization amount that is greater than an authorization amount that was authorized for a previous purchase, wherein capture of the previous purchase was deferred, and wherein the over-authorization amount includes the purchase amount and an additional purchase amount of the previous purchase.

An action 212 comprises determining whether to settle any pending deferred purchases. In some cases, the action 212 may comprise determining whether a wait period has expired, where the wait period is a period of time after the earliest deferred purchase that has not yet been settled. If the wait period has expired, the action 206 is performed of settling any pending deferred purchases. The action 208 follows the action 206, and after indicating successful processing of the transaction amount the method returns to the action 202 to receive another transaction request.

If the wait period has not expired, an action 214 is performed of indicating, to the requesting entity or device, that the received transaction has been successfully processed. For example, the payment service may send a communication to the seller device or to the buyer device, causing the device to display, via a display, an indication that the purchase amount of the transaction has been settled. In some cases, the indication may not indicate that any deferment actions have been taken.

An action 216 is performed of determining whether a new request for a purchase between the buyer and the seller has been received. If a new request is received, the method 200 returns to the action 202 and the previously described actions are repeated. If a new request has not been received, the method returns to the action 210 to determine whether the wait period has expired or more generally whether the deferment criteria has been satisfied by expiration of the wait period.

FIG. 3 shows an example method 300 of implementing a deferment criterion, which corresponds to the action 204 of FIG. 2. For purposes of discussion, the term “pending purchases” will be used to refer to a currently requested purchase (such as the purchase requested by the purchase transaction request receive in the action 202) as well as any previously deferred purchases that have not yet been settled.

An action 302 comprises making an economic decision regarding whether it is economically worthwhile to defer settlement of the current purchase. The action 302 can be performed in various ways.

As one example, the action 302 may comprise determining whether the amount of the currently requested purchase exceeds an amount threshold. Such an amount threshold may be defined in light of average interchange assessments for purchases of different amounts, for example, and/or on the ratios of purchase amounts to interchange assessments for individual transactions. For example, the amount threshold may be defined as a value at which the interchange assessment for an individual transaction is less than a certain percentage of the transaction.

The action 302 may similarly comprise determining whether the aggregate amount of pending purchases between the buyer and the seller, including the currently requested purchase, exceeds the amount threshold.

If at any point the amount of the current purchase or the aggregate amount of pending purchases between the buyer and the seller exceeds the amount threshold, the method goes to the action 206 of FIG. 2, which comprises settling all pending purchases between the buyer and the seller.

In some implementations, the action 302 may include estimating interchange assessments for individual purchase transactions, based in part on the type of transaction, the type of payment instrument, and other factors. In some implementations, historical transaction data may be analyzed to identify transactions having similar characteristics, and interchange assessments may be estimated based on such historical transactions. In these cases, the economic decision 302 may be made by calculating a ratio of an estimated interchange fee to an individual or aggregate purchase amount, and comparing the ratio to a defined threshold.

If the economic decision 302 indicates that it may be economically profitable to defer settlement of the current purchase, an action 304 is performed of determining the likelihood of a subsequent purchase by the buyer from the seller. The action 304 may comprise determining the likelihood of the buyer making a subsequent purchase within the wait period of the action 212, for example. Depending on the implementation, the wait period may range from hours to days. In some embodiments, for example, the wait period might comprise 12 hours. In other embodiments the wait period might comprise 7 days.

The action 304 may be performed by examining and/or analyzing past purchases of the buyer from the seller, based on stored transaction data. For example, the transaction data may be analyzed to predict a purchase frequency at which the buyer makes purchases from the seller, as well as an indication of a reliability of the frequency prediction. In some embodiments, machine learning techniques may be used to analyze historical purchase transaction data and to produce a predictive model that can be applied to transaction data relating to the buyer and seller to produce a probability metric indicating the likelihood that the buyer will make another purchase from the seller within a specified time period.

An action 306 comprises comparing the likelihood of a future purchase, as determined in the action 304, to a likelihood threshold T1. If the likelihood does not exceed the likelihood threshold T1, execution continues with the action 206 of FIG. 2, which comprises settling all pending transactions between the buyer and the seller.

If the likelihood does exceed the likelihood threshold T1, an action 308 is performed, of determining a risk of deferring settlement of the purchase, referred to herein as a deferment risk. The deferment risk comprises the risk that settlement at a later time may not be possible or may result in a chargeback. As an example, in the time between the purchase and a deferred settlement, the funds of the buyer account may become depleted. Other issues may similarly arise such that it may not be possible to successfully settle deferred payments.

The settlement risk may be determined by analyzing purchase histories of the buyer including whether the payment instrument of the buyer has resulted in previous chargebacks and other chargeback predictors. Other risk factors may also be analyzed, such as whether the current purchase is consistent with previous uses of the payment instrument, whether the purchase is being made in a location from which purchase are frequently made using the payment instrument, whether payments to other merchants have also been deferred, and so forth.

Seller factors may also be considered when analyzing risk. Seller factors, may include actual and implied merchant categories, whether seller transactions are predominantly local or international, typical sizes of merchant transactions, customer feedback including direct feedback and social media feedback, information from third-party sources, and various other chargeback predictors.

Risk factors may relate to the specific requested purchase transaction, or may relate more generally to risks associated with the seller and/or merchant.

In some embodiments, machine learning techniques may be used, based on historical transaction data stored by the payment service, to predict the risk associated with deferred settlement of a particular purchase, based on either or both of the seller or buyer factors.

An action 310 is then performed, comprising comparing the deferment risk to a risk threshold T2. If the deferment risk is greater than the risk threshold T2, execution continues with the action 206 of FIG. 2, which comprises settling all pending transactions between the buyer and the seller. If the deferment risk is not greater than the risk threshold T2, execution continues with the action 210 of FIG. 2.

The deferment techniques described above may in some embodiments be used by the payment service without the knowledge of the sellers or buyers. In other embodiments, merchants and/or buyers may be asked to opt in before applying the described deferment methods to transactions involving the buyers and/or sellers. When asking a buyer to opt in, the buyer may be offered promotions, such as enhancements to a customer loyalty program. Incentives to a seller may include passing on savings of reduced processing fees to the sellers.

Various different techniques may be used to determine that a transaction should be deferred and/or that previously deferred transactions should now be settled. The parameters upon which these decisions are based may be based upon characteristics and routines of individual merchants and customers, which are known to the payment service by analyzing past sales and purchases of merchants and customers, respectively. As an example, analyzing past sales by a merchant might lead to higher numbers of deferred settlements during historical rush hours, and lower numbers of deferred settlements during slower sales periods.

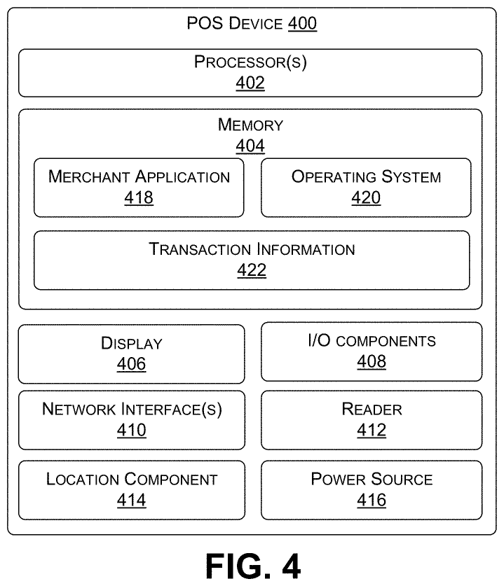

FIG. 4 illustrates select components of a client device 400, which may be used as an example of either the seller device 106 or the buyer device 128. according to some implementations. The device 400 may be any suitable type of computing device, e.g., mobile, semi-mobile, semi-stationary, or stationary. Some examples of the device 400 may include tablet computing devices; smart phones and mobile communication devices; laptops, netbooks and other portable computers or semi-portable computers; desktop computing devices, terminal computing devices and other semi-stationary or stationary computing devices; dedicated register devices; wearable computing devices, or other body-mounted computing devices; or other computing devices capable of sending communications and performing the functions according to the techniques described herein.

In the illustrated example, the device 400 includes at least one processor 402, memory 404, a display 406, one or more input/output (I/O) components 408, one or more network interfaces 410, at least one card reader 412, at least one location component 414, and at least one power source 416.

Each processor 402 may itself comprise one or more processors or processing cores. For example, the processor 402 can be implemented as one or more microprocessors, microcomputers, microcontrollers, digital signal processors, central processing units, state machines, logic circuitries, and/or any devices that manipulate signals based on operational instructions. In some cases, the processor 1802 may be one or more hardware processors and/or logic circuits of any suitable type specifically programmed or configured to execute the algorithms and processes described herein. The processor 402 can be configured to fetch and execute computer-readable processor-executable instructions stored in the memory 404.

Depending on the configuration of the device 400, the memory 404 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 404 may include, but is not limited to, RAM, ROM, EEPROM, flash memory, solid-state storage, magnetic disk storage, optical storage, and/or other computer-readable media technology. Further, in some cases, the device 400 may access external storage, such as RAID storage systems, storage arrays, network attached storage, storage area networks, cloud storage, or any other medium that can be used to store information and that can be accessed by the processor 402 directly or through another computing device or network. Accordingly, the memory 404 may be computer storage media able to store instructions, modules or components that may be executed by the processor 402. Further, when mentioned, non-transitory computer-readable media exclude media such as energy, carrier signals, electromagnetic waves, and signals per se.

The memory 404 may be used to store and maintain any number of functional components that are executable by the processor 402. In some implementations, these functional components comprise instructions or programs that are executable by the processor 402 and that, when executed, implement operational logic for performing the actions and services attributed above to the device 400. Functional components of the device 400 stored in the memory 404 may include a seller application 418, which may present an interface on the device 400 to enable the seller to conduct transactions, receive payments, and so forth, as well as communicating with the payment service 108 for processing payments and sending transaction information. Further, the seller application 418 may present an interface to enable the seller to manage the seller's account, and the like.

Additional functional components may include an operating system 420 for controlling and managing various functions of the device 400 and for enabling basic user interactions with the device 400. The memory 404 may also store transaction information/data 422 that is received based on the seller associated with the device 400 engaging in various transactions with buyers.

In addition, the memory 404 may also store data, data structures and the like, that are used by the functional components. For example, this data may include item information that includes information about the items offered by the seller, which may include images of the items, descriptions of the items, prices of the items, and so forth. Depending on the type of the device 400, the memory 404 may also optionally include other functional components and data, which may include programs, drivers, etc., and the data used or generated by the functional components. Further, the device 400 may include many other logical, programmatic and physical components, of which those described are merely examples that are related to the discussion herein.

The network interface(s) 410 may include one or more interfaces and hardware components for enabling communication with various other devices over a network or directly. For example, network interface(s) 410 may enable communication through one or more of the Internet, cable networks, cellular networks, wireless networks (e.g., Wi-Fi) and wired networks, as well as close-range communications such as Bluetooth®, Bluetooth® low energy, and the like, as additionally enumerated elsewhere herein.

The I/O components 408 may include speakers, a microphone, a camera, various user controls (e.g., buttons, a joystick, a keyboard, a keypad, etc.), and/or a haptic output device, and so forth.

In addition, the device 400 may include or may be connectable to a payment instrument reader 412. In some examples, the reader 412 may plug in to a port in the device 400, such as a microphone/headphone port, a data port, or other suitable port. In other instances, the reader 412 is integral with the device 400. The reader 412 may include a read head for reading a magnetic strip of a payment card, and further may include encryption technology for encrypting the information read from the magnetic strip. Alternatively, numerous other types of card readers may be employed with the device 400 herein, depending on the type and configuration of a particular seller device 106.

The location component 414 may include a GPS device able to indicate location information, or the location component 414 may comprise any other location-based sensor. The device 400 may also include one or more additional sensors (not shown), such as an accelerometer, gyroscope, compass, proximity sensor, and the like. Additionally, the device 400 may include various other components that are not shown, examples of which include removable storage, a power control unit, and so forth.

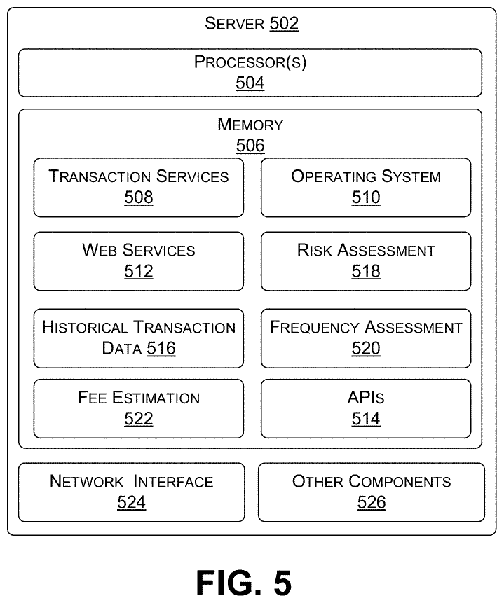

FIG. 5 shows an example of a server 500, which may be used to implement the functionality of the payment service 108 as described herein. Generally, the payment service 108 may be implemented by a plurality of servers 500.

In the illustrated example, the server 502 includes at least one processor 504 and associated memory 506. Each processor 504 may itself comprise one or more processors or processing cores. For example, the processor 504 can be implemented as one or more microprocessors, microcomputers, microcontrollers, digital signal processors, central processing units, state machines, logic circuitries, and/or any devices that manipulate signals based on operational instructions. In some cases, the processor 504 may be one or more hardware processors and/or logic circuits of any suitable type specifically programmed or configured to execute the algorithms and processes described herein. The processor 504 can be configured to fetch and execute computer-readable processor-executable instructions stored in the memory 506.

Depending on the configuration of the server 502, the memory 506 may be an example of tangible non-transitory computer storage media and may include volatile and nonvolatile memory and/or removable and non-removable media implemented in any type of technology for storage of information such as computer-readable processor-executable instructions, data structures, program modules or other data. The memory 506 may include, but is not limited to, RAM, ROM, EEPROM, flash memory, solid-state storage, magnetic disk storage, optical storage, and/or other computer-readable media technology. Further, in some cases, the server 502 may access external storage, such as RAID storage systems, storage arrays, network attached storage, storage area networks, cloud storage, or any other medium that can be used to store information and that can be accessed by the processor 504 directly or through another computing device or network. Accordingly, the memory 506 may be computer storage media able to store instructions, modules or components that may be executed by the processor 504. Further, when mentioned, non-transitory computer-readable media exclude media such as energy, carrier signals, electromagnetic waves, and signals per se.

The memory 506 may be used to store and maintain any number of functional components that are executable by the processor 504. In some implementations, these functional components comprise instructions or programs that are executable by the processor 504 and that, when executed, implement operational logic for performing the actions and services attributed above to the payment service 108. Functional components stored in the memory 506 may include a transaction services component 508 that receives, processes and responds to transaction requests such as authorization requests, capture requests, and quick deposit requests in accordance with the preceding discussion.

Additional functional components may include an operating system 510 and a web services component 512. The memory 506 may also store APIs (application programming interfaces) 514 that are used for communications between the server 502 and the seller device 106 or the buyer device 128. The memory 506 may also store data, data structures and the like, that are used by the functional components. For example, the memory 506 may store historical transaction data 516 corresponding to purchase transactions that have been processed over time.

Functional components stored in the memory 506 may further include a risk assessment module 518 that analyzes risk associated with deferring individual payments. The risk assessment module 518 may analyze aspects of the historical data 516, for example, to create a predictive model that determines a risk metric for any given transaction.

Functional components may also include a frequency assessment module 520 that analyzes the historical transaction data 516 to determine frequencies of purchases by individual buyers from individual sellers. The frequency assessment module may be based on a predictive model, and may estimate the likelihood that a particular buyer will make a purchase from a specified seller within a specified time period.

The functional components may also include a fee estimation module 522, which may be configured to predict or estimate interchange assessments for individual purchases. The fee estimation module 522 may analyze the historical data 516 to find transactions that were similar to a current transaction, and to thereby determine an interchange assessment that might typically be associated with a particular transaction of a corresponding amount and type.

The server 502 may have a network communications interface 524, such as an Ethernet communications interface, which provides communication by the server 502 with other servers, with the Internet, and ultimately with the devices 106 and 128.

The server 502 may of course include many other logical, programmatic, and physical components 526 that are not specifically described herein.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by one or more computing devices of a transaction processing service, the method comprising:
receiving, by the one or more computing devices and from point-of-sale (POS) devices operable by merchants associated with the transaction processing service, transaction data to be processed by the one or more computing devices on behalf of the merchants, wherein each POS device of the POS devices is associated with an instance of a merchant application that configures the POS device to generate a portion of the transaction data and send the portion of the transaction data to the one or more computing devices over a network;
receiving, by the one or more computing devices and from a POS device operable by a merchant of the merchants, first transaction data associated with a first transaction between a first customer and the merchant, wherein the first transaction data includes first payment instrument information;
authorizing, by the one or more computing devices, a first payment associated with the first transaction, wherein the authorizing includes:
transmitting, by the one or more computing devices and to an acquirer or to a payment instrument network, the first payment instrument information; and
receiving, by the one or more computing devices, an authorization of the first payment from the acquirer or the payment instrument network;
receiving, by the one or more computing devices and from the POS device, second transaction data associated with a second transaction between a second customer and the merchant, wherein the second transaction data includes second payment instrument information;
authorizing, by the one or more computing devices, a second payment associated with the second transaction, wherein the authorizing includes:
transmitting, by the one or more computing devices and to the acquirer or to the payment instrument network, the second payment instrument information; and
receiving, by the one or more computing devices, an authorization of the second payment from the acquirer or the payment instrument network;
determining, by the one or more computing devices, a capture wait period to wait after the first transaction before sending a capture request for the first payment and the second payment;
after authorizing the first payment, after authorizing the second payment, and after the capture wait period has expired, sending, by the one or more computing devices, the capture request for the first payment and the second payment, wherein sending the capture request comprises transmitting, by the one or more computing devices and to the acquirer or to the payment instrument network, the first payment instrument information and the second payment instrument information in a batch; and
receiving, by the one or more computing devices and from the acquirer or the payment instrument network, a confirmation of capture of the first payment and the second payment.

2. The method as claim 1 recites, wherein determining the capture wait period is based at least in part on a determination that the first payment is eligible for a deferred capture.

3. The method as claim 2 recites, further comprising:
determining that the first payment does not exceed a threshold payment amount,
wherein the determination that the first payment is eligible for a deferred capture is based at least in part on the first payment not exceeding the threshold payment amount.

4. The method as claim 2 recites, further comprising:
determining a likelihood of a chargeback related to the first transaction,
wherein the determination that the first payment is eligible for a deferred capture is based at least in part on the likelihood.

5. The method as claim 2 recites, further comprising:
determining an expected amount of fees associated with the capture of the first payment,
wherein the determination that the first payment is eligible for a deferred capture is based at least in part on the expected amount of fees.

6. The method as claim 1 recites, further comprising:
determining a probability that the second customer will make a purchase from the merchant within the capture wait period,
wherein determining the capture wait period is based at least in part on the probability.

7. The method as claim 1 recites, further comprising:
exposing, by the one or more computing devices, an application programming interface (API) that is configured to provide services of the transaction processing service to the POS devices,
wherein receiving, by the one or more computing devices and from the POS device, the first transaction data comprises receiving the first transaction data through the API.

8. A method performed by one or more computing devices of a transaction processing service, the method comprising:
receiving, by the one or more computing devices and from point-of-sale (POS) devices operable by merchants associated with the transaction processing service, transaction data to be processed by the one or more computing devices on behalf of the merchants, wherein each POS device of the POS devices is associated with an instance of a merchant application that configures the POS device to generate a portion of the transaction data and send the portion of the transaction data to the one or more computing devices over a network;
receiving, by the one or more computing devices and from a POS device operable by a merchant of the merchants, first transaction data associated with a first transaction between a customer and the merchant, wherein the first transaction data includes first payment instrument information;
authorizing, by the one or more computing devices, a first payment associated with the first transaction, wherein the authorizing includes:
transmitting, by the one or more computing devices and to an acquirer or to a payment instrument network, the first payment instrument information; and
receiving, by the one or more computing devices and from the acquirer or the payment instrument network, an authorization of the first payment;
receiving, by the one or more computing devices and from the POS device operable by the merchant, second transaction data associated with a second transaction between the customer and the merchant, wherein the second transaction data includes second payment instrument information;
authorizing, by the one or more computing devices, a second payment associated with the second transaction, wherein the authorizing includes:
transmitting, by the one or more computing devices and to the acquirer or the payment instrument network, the second payment instrument information; and
receiving, by the one or more computing devices from the acquirer or the payment instrument network, an authorization of the second payment;
determining, by the one or more computing devices, a capture wait period to wait after the first transaction before sending a capture request for the first payment and the second payment; and
after authorizing the first payment, after authorizing the second payment, and after expiration of the capture wait period, sending, by the one or more computing devices, the capture request for the first payment and the second payment, wherein sending the capture request comprises transmitting, by the one or more computing devices and to the acquirer or to the payment instrument network, the first payment instrument information and the second payment instrument information in a batch;
receiving, by the one or more computing devices, a confirmation of the capture of the first payment and the second payment from the acquirer or the payment instrument network.

9. The method as claim 8 recites, further comprising:
determining a probability that the customer will make a second purchase from the merchant within the capture wait period,
wherein determining the capture wait period is based at least in part on the probability.

10. The method as claim 8 recites, further comprising:
determining, by the one or more computing devices, a purchase history of purchases by the customer from the merchant,
wherein determining the capture wait period is based at least in part on analyzing the purchase history.

11. The method as claim 10 recites, wherein analyzing the purchase history comprises using a machine learning model trained on historical transaction data.

12. The method as claim 8 recites, further comprising sending a notification to the POS device that causes presentation by the POS device, at least partly via a display, of an indication that the first payment has been settled.

13. The method as claim 8 recites, wherein the first payment instrument comprises a same payment instrument as the second payment instrument.

14. A method performed by one or more computing devices of a transaction processing service, the method comprising:
receiving, at the one or more computing devices and from point-of-sale (POS) devices operable by merchants associated with the transaction processing service, transaction data to be processed by the one or more computing devices on behalf of the merchants, wherein each POS device of the POS devices is associated with an instance of a merchant application that configures the POS device to generate a portion of the transaction data and send the portion of the transaction data to the one or more computing devices over a network;
receiving, by the one or more computing devices and from a first instance of the merchant application executing on a POS device operable by a merchant of the merchants, first payment instrument information associated with a first transaction to be processed by the one or more computing devices on behalf of the merchant;
receiving, by the one or more computing devices and from the first instance of the merchant application executing on the POS device operable by the merchant, second payment instrument information associated with a second transaction to be processed by the one or more computing devices on behalf of the merchant;
determining, by the one or more computing devices, a processing wait period to wait after the first transaction before processing the first transaction and the second transaction; and
at least partly responsive to expiration of the processing wait period, processing, by the one or more computing devices, the first transaction and the second transaction in a batch.

15. The method as claim 14 recites, further comprising:
determining, by the one or more computing devices, a settlement wait period to wait after processing the first transaction and the second transaction before settling, to the merchant, at least a portion of a first payment associated with the first transaction and at least a portion of a second payment associated with the second transaction; and
after the settlement wait period, settling, by the one or more computing devices, the at least the portion of the first payment and the at least the portion of second payment to the merchant.

16. The method as claim 14 recites, wherein the processing wait period is based at least in part on the likelihood that the customer will make a second purchase from the merchant within the processing wait period.

17. The method as claim 14 recites, wherein determining the processing wait period includes determining, by the one or more computing devices, that a risk of deferring processing of the first transaction does not exceed a risk threshold.

18. The method as claim 14 recites, wherein processing the first transaction and the second transaction in the batch comprises submitting, by the one or more computing devices and to an acquirer or to a payment instrument network, a single aggregated capture request for both the first transaction and the second transaction.

19. The method as claim 14 recites, further comprising:
sending, by the one or more computing devices, a notification to the POS device that causes presentation by the POS device, at least partly via a display, of a notification that both the first transaction and second transaction have been processed in the batch.

20. The method as claim 14 recites, further comprising:
before determining the processing wait period, authorizing, by the one or more computing devices, a first payment associated with the first transaction and a second payment associated with the second transaction, wherein the authorizing includes:
transmitting, by the one or more computing devices and to an acquirer or a payment instrument network, the first payment instrument information and the second payment instrument information; and
receiving, by the one or more computing devices and from the acquirer or the payment instrument network, an authorization of the first payment and the second payment.
